(19) United States
(12) Patent Application Publication
(10) Pub. No.: US 2026/0328360 A1
(43) Pub. Date: Oct. 22, 2026

(54) TRUCK WIRE HARNESS ASSEMBLY FOR LIGHTS

(71) Applicant: Terad Patents, LLC, Carroll, IA (US)

(72) Inventors: David T. Wurzer, Carroll, IA (US); Terry D. Wurzer, Carroll, IA (US); Adam J. Wurzer, Carroll, IA (US)

(21) Appl. No.: 19/652,898

(22) Filed: Apr. 20, 2026

Related U.S. Application Data
(60) Provisional application No. 63/792,615, filed on Apr. 22, 2025.

(51) Int. Cl. F21S 43/19; B60R 16/02; F21V 23/00; F21V 23/06; F21W 103/20; F21W 103/35; F21W 103/45; H01B 7/00

(52) U.S. Cl. CPC F21S 43/195; B60R 16/0215; F21V 23/001; F21V 23/06; H01B 7/0045; F21W 2103/20; F21W 2103/35; F21W 2103/45

(57) ABSTRACT

A wire harness assembly and method are disclosed. The wire harness assembly may be configured for lighting of a passenger vehicle, truck, or trailer. The wire harness assembly may include a whip configured to couple to at least one truck-side lighting output element of the truck. The wire harness assembly may further include a parallel-wired branch element configured to couple to the whip. The parallel-wired branch element may include a first connector of the parallel-wired branch element configured to be removably couplable to the connector of the whip, and a plurality of second connectors of the parallel-wired branch element wired to and thereby coupled to the first connector of the parallel-wired branch element.

### CROSS-REFERENCE TO RELATED APPLICATIONS

The present application claims the benefit of U.S. Provisional Application Ser. No. 63/792,615, filed Apr. 22, 2025, which is incorporated herein by reference in its entirety.

### TECHNICAL FIELD

The present disclosure relates generally to vehicle electrical systems, and more particularly to branched wiring for supplying and distributing lighting functions on platforms such as trucks and trailers.

### BACKGROUND

Trucks often incorporate an array of lighting functions-taillight, turn-signal, brake, reverse, and auxiliary lights-mounted directly on the rear bumper, side of vehicle, front bumper, or the like. Each of these functions is typically driven by a vehicle-side lighting output circuit. In many production vehicles, the original equipment manufacturer (OEM) wiring for these outputs terminates in a connector, series of connectors, or series of wires located well forward of the bumper, for example under the bodywork, in the tailgate well, or behind an inner panel.

Aftermarket or replacement bumper lights must therefore be connected back to those chassis-mounted connectors. Conventional practices rely on multiple discrete leads or the like to extend each signal to its respective lamp or functionality. This point-to-point hard-wiring approach can be time-consuming and error-prone, since each conductor must be traced, labeled, spliced, and sealed separately. Every splice or butt-connector represents a potential failure point and complicates future maintenance or light replacement.

In addition, the growing proliferation of auxiliary and custom lighting configurations has driven the need for better solutions. Complications may arise when multiple lighting elements must receive different electrical signals (such as brake, reverse, or turn signals) from a limited number of factory light signal sources.

Accordingly, there remains a need for improved approaches to connecting multiple lighting elements to a truck's electrical system that maintain proper functionality while simplifying installation and maintenance processes.

### SUMMARY

A wire harness assembly configured for lighting of a truck is disclosed in accordance with one or more illustrative embodiments of the present disclosure. In one illustrative embodiment, the wire harness assembly includes a whip configured to couple to at least one truck-side lighting output element of the truck. In another illustrative embodiment, the whip includes at least one couplable element configured to couple to the at least one truck-side lighting output element, where the at least one truck-side lighting output element and the at least one couplable element each include at least one of a connector or a plurality of wire leads. In another illustrative embodiment, the whip includes a connector opposite relative to the at least one couplable element, where the connector is electrically wired to and thereby coupled to the at least one couplable element. In another illustrative embodiment, the wire harness assembly includes a parallel-wired branch element configured to couple to the whip. In another illustrative embodiment, the parallel-wired branch element includes a first connector of the parallel-wired branch element configured to be removably couplable to the connector of the whip. In another illustrative embodiment, the parallel-wired branch element includes a plurality of second connectors of the parallel-wired branch element wired to and thereby coupled to the first connector of the parallel-wired branch element. In another illustrative embodiment, the plurality of second connectors of the parallel-wired branch element are wired in parallel such that each of the plurality of second connectors includes one or more common signal lines, where the wire harness assembly is configured to couple to a plurality of light assemblies configured to be addressable.

In a further aspect, the wire harness assembly may include an expandable parallel-wired branch element configured to couple to a single second connector of the parallel-wired branch element, where the expandable parallel-wired branch element includes a first connector of the expandable parallel-wired branch element configured to be removably couplable to the single second connector of the parallel-wired branch element, and a plurality of second connectors of the expandable parallel-wired branch element wired to and thereby coupled to the first connector of the expandable parallel-wired branch element, where the plurality of second connectors of the expandable parallel-wired branch element are wired in parallel such that each of the plurality of second connectors of the expandable parallel-wired branch element includes one or more common signal lines.

In a further aspect, the wire harness assembly may include the plurality of light assemblies, each light assembly including a light and a light connector configured to be removably coupled to a second connector of the plurality of second connectors of the parallel-wired branch element.

In a further aspect, the plurality of light assemblies may include a taillight light assembly configured to respond to at least one of a taillight turn signal or an auxiliary signal, a reverse light assembly configured to respond to at least one of a reverse signal or an auxiliary signal, a brake light assembly configured to respond to at least one of a brake signal or an auxiliary signal, and an auxiliary light assembly configured to respond to an auxiliary signal.

In a further aspect, the plurality of second connectors of the parallel-wired branch element may include at least five second connectors.

In a further aspect, the plurality of second connectors of the parallel-wired branch element may include at least eight second connectors.

In a further aspect, each of the plurality of second connectors of the parallel-wired branch element may include a polarization-keyed, sealed multi-pin connector including a Deutsch connector.

A method of providing a wire harness assembly configured for lighting of a truck is disclosed in accordance with one or more illustrative embodiments of the present disclosure. In one illustrative embodiment, the method includes providing a whip including at least one couplable element and a connector electrically wired to and thereby coupled to the at least one couplable element. In another illustrative embodiment, the method includes providing a parallel-wired branch element including a first connector and a plurality of second connectors electrically wired to and thereby coupled to the first connector. In another illustrative embodiment, the method includes electrically coupling the at least one couplable element to at least one truck-side lighting output element of the truck. In another illustrative embodiment, the method includes removably coupling the connector of the whip to the first connector of the parallel-wired branch element.

In a further aspect, the method may include routing the plurality of second connectors of the parallel-wired branch element proximate the truck.

In a further aspect, the method may include removably coupling a light connector of a light assembly to at least one of the plurality of second connectors of the parallel-wired branch element.

In a further aspect, the light assembly may include a taillight light assembly configured to respond to a taillight turn signal.

In a further aspect, the method may include coupling an expandable parallel-wired branch element to a single second connector of the parallel-wired branch element, the expandable parallel-wired branch element including a plurality of second connectors wired in parallel such that each second connector includes one or more common signal lines available at the single second connector of the parallel-wired branch element.

In a further aspect, the method may include removably coupling additional light connectors of additional light assemblies to the plurality of second connectors of the expandable parallel-wired branch element.

In a further aspect, the wire harness assembly may include the plurality of second connectors of the parallel-wired branch element including at least eight second connectors.

A system is disclosed in accordance with one or more illustrative embodiments of the present disclosure. In one illustrative embodiment, the system includes a panel of a truck. In another illustrative embodiment, the system includes a wire harness assembly configured for the panel of the truck. In another illustrative embodiment, the wire harness assembly includes a whip configured to couple to at least one truck-side lighting output element of the truck. In another illustrative embodiment, the whip includes at least one couplable or bare wire element configured to couple to the at least one truck-side lighting output element, where the at least one truck-side lighting output element and the at least one couplable or bare wire element each include at least one of a connector or a plurality of wire leads. In another illustrative embodiment, the whip includes a connector opposite relative to the at least one couplable or bare wire element, where the connector is electrically wired to and thereby coupled to the at least one couplable or bare wire element. In another illustrative embodiment, the wire harness assembly includes a parallel-wired branch element configured to couple to the whip. In another illustrative embodiment, the parallel-wired branch element includes a first connector of the parallel-wired branch element configured to be removably couplable to the connector of the whip. In another illustrative embodiment, the parallel-wired branch element includes a plurality of second connectors of the parallel-wired branch element wired to and thereby coupled to the first connector of the parallel-wired branch element. In another illustrative embodiment, the plurality of second connectors of the parallel-wired branch element are wired in parallel such that each of the plurality of second connectors includes one or more common signal lines, where the wire harness assembly is configured to couple to a plurality of light assemblies configured to be addressable.

In a further aspect, the system may include an expandable parallel-wired branch element configured to couple to a single second connector of the parallel-wired branch element, where the expandable parallel-wired branch element includes a first connector of the expandable parallel-wired branch element configured to be removably couplable to the single second connector of the parallel-wired branch element, and a plurality of second connectors of the expandable parallel-wired branch element wired to and thereby coupled to the first connector of the expandable parallel-wired branch element, where the plurality of second connectors of the expandable parallel-wired branch element are wired in parallel such that each of the plurality of second connectors of the expandable parallel-wired branch element includes the one or more common signal lines available at the single second connector of the parallel-wired branch element.

In a further aspect, the system may include the plurality of light assemblies, each light assembly including a light and a light connector configured to be removably coupled to a second connector of the plurality of second connectors of the parallel-wired branch element.

In a further aspect, the plurality of light assemblies may include a taillight light assembly configured to respond to a taillight turn signal, a reverse light assembly configured to respond to a reverse signal, and a brake light assembly configured to respond to a brake signal.

In a further aspect, the plurality of second connectors of the parallel-wired branch element may include at least five second connectors.

In a further aspect, the plurality of second connectors of the parallel-wired branch element may include at least eight second connectors.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are exemplary and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1A is a schematic block diagram of a wire harness assembly configured to distribute truck-side lighting output signals to a plurality of light assemblies, in accordance with one or more embodiments of the present disclosure.

FIG. 1B is a schematic block diagram further illustrating an optional expandable parallel-wired branch element that may be coupled to one of the second connectors of the parallel-wired branch element to increase the number of available connection points, in accordance with one or more embodiments of the present disclosure.

FIG. 1C is a schematic block diagram of a wire harness assembly including a parallel-wired branch element that includes a housing, in accordance with one or more embodiments of the present disclosure.

FIG. 2 is a perspective view of an assembled view of the wire harness assembly showing the whip and the parallel-wired branch element, in accordance with one or more embodiments of the present disclosure.

FIG. 3A is a perspective view of light assemblies of a rear bumper of a truck, in accordance with one or more embodiments of the present disclosure.

FIG. 3B are additional perspective views of light assemblies of various panels of a truck, in accordance with one or more embodiments of the present disclosure.

FIG. 4 is a flow diagram depicting a method for providing a wire harness assembly, in accordance with one or more embodiments of the present disclosure.

FIG. 5 is a parallel-wired branch element including a housing rather than a branched wire harness, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

Conventional truck lighting methods may require routing each unique signal (e.g., brake lights, reverse lights, turn signals) all the way from the light assembly to the truck-side lighting signal output wires of the truck, which could span half of, or an entire distance, of the truck. Modification of such a system may require disassembly of entire sections and panels of the truck or reaching into tight spaces in order to route a lighting type that does not have an existing wire or that needs to be replaced due to damage. This may require long and costly cable lengths and take significant amounts of labor.

Broadly speaking, embodiments of the concepts disclosed herein may provide a wire harness assembly with universal parallel signal capability configured for front, rear, and/or side lighting of a truck. By using a parallel wiring approach where any light assembly may be connected to any connector, the function of each light assembly may be determined by how each light assembly is internally addressed or configured, rather than by which connector it is plugged into. The wire harness assembly may include a parallel-wired branch element that splits and delivers a common set of power and signals to each of a plurality of intermediary whips or light assemblies. In some embodiments, the wire harness assembly may further include one or more additional/expandable parallel-wired branch elements for providing additional connection points while maintaining the same set of signals. The whip and/or light assemblies themselves may be individually configurable (e.g., via mechanical switches, pin-out connectors, wiring, or the like; and/or via software) and swappable to adapt to different truck signal configurations, allowing flexible installation and easy re-configuration of lighting systems.

It is noted that in one case, conventional methods of adding lights to a bumper of a truck was estimated to take eight hours while the method of embodiments herein for the same installation elapsed about fifteen minutes due to modular benefits of universal common addressable signal lines shared with the rest of the system. For example, in some cases, disassembly and re-assembly of certain portions (e.g., bumper area) of the vehicle to route lights with different signal requirements (e.g., brake signals) may be eliminated entirely because if an existing universal signal line is already present then branched copies of that signal may be connected in parallel to be used as desired without routing all the way back to the vehicle source, substantially reducing routing requirements and installation labor when adding new lights to an existing configuration.

Note that while a truck and truck panel are used as examples in the present disclosure for illustrative clarity, any system, method, element, or description herein is not limited to trucks unless otherwise noted, but rather is herein extended to any vehicle or platform such as a passenger car, trailer, or the like.

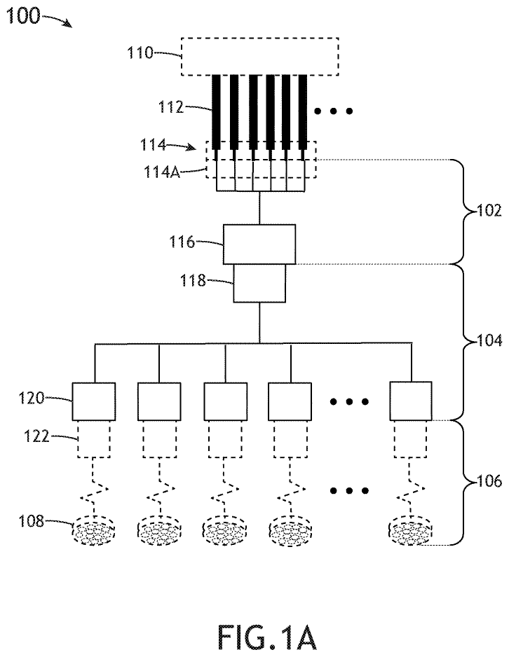

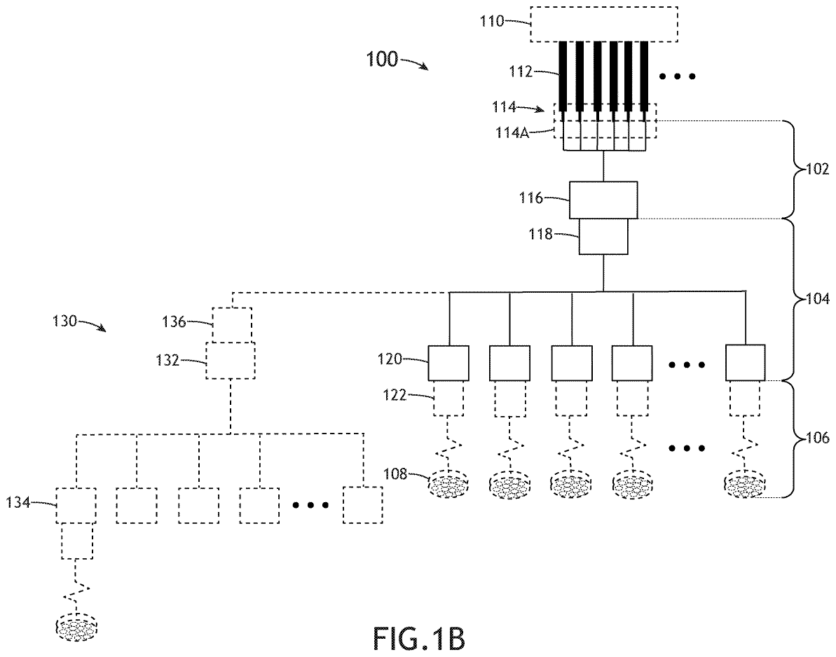

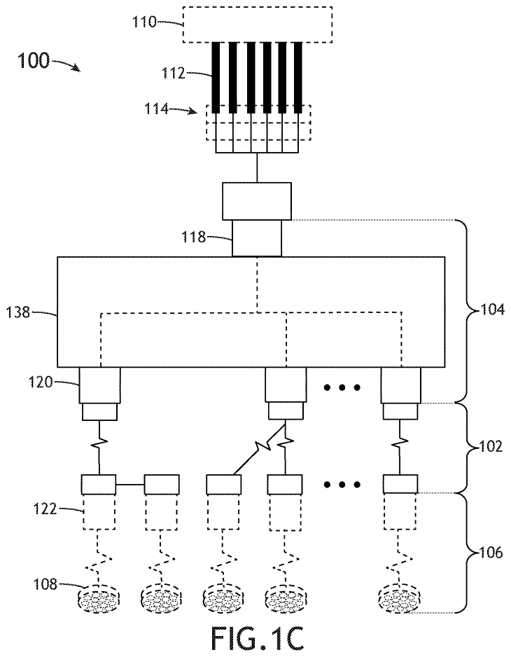

FIG. 1A illustrates a schematic block diagram of a wire harness assembly 100 configured to distribute truck-side lighting output signals to a plurality of light assemblies 106, in accordance with one or more embodiments of the present disclosure.

In embodiments, the wire harness assembly 100 includes a whip 102 and a parallel-wired branch element 104 configured to couple to the whip 102. The combination of the whip 102 (e.g., a short cable assembly configured to bridge the truck-side factory wiring to the parallel-wired branch element 104) and the parallel-wired branch element 104 may provide signals to light assemblies 106 coupled to the parallel-wired branch element 104.

For purposes of the present disclosure, unless otherwise noted, the term “signals” or “signal” may include power (e.g., electrical power), data (e.g., light blinking pattern data configured to be used to control a blinking pattern of a light assembly 106; light color data configured to be used to control a light color; light intensity data), or both. In some embodiments, the signal may include additional multiple signals, such as two or more power lines and/or two or more data signals. In some embodiments, the signal may include an auxiliary signal. For example, the auxiliary signal may be configured to provide power for an auxiliary light of the light assembly 106. For instance, the auxiliary light may include a light of a second auxiliary color different from a first (main) color of a light assembly 106. In this way, the light assembly 106 may include dual colors.

In embodiments, the whip 102 and the parallel-wired branch element 104 cooperate to transmit lighting output signals from a vehicle side location to a series of light assemblies 106. The depicted arrangement is suitable, for example, for installation near, behind, and/or within a truck (e.g., rear bumper) where multiple lighting functions (e.g., brake, turn, reverse, marker, and/or auxiliary) are desired.

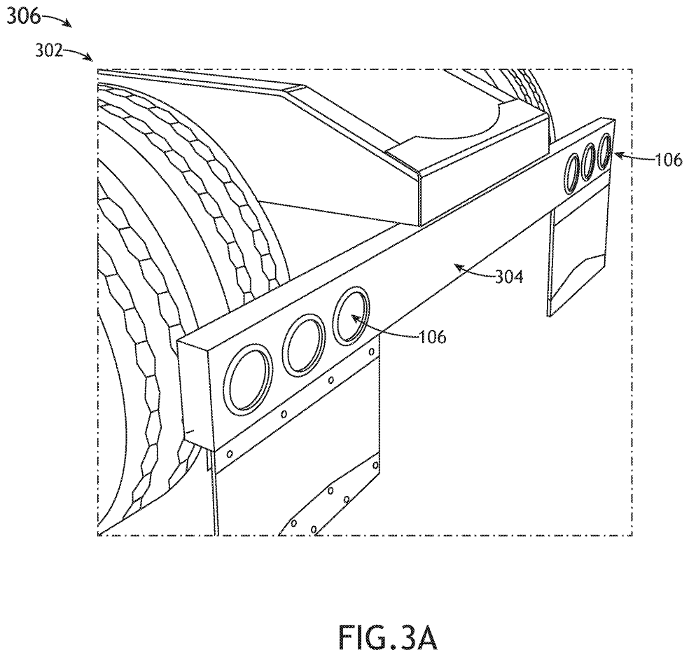

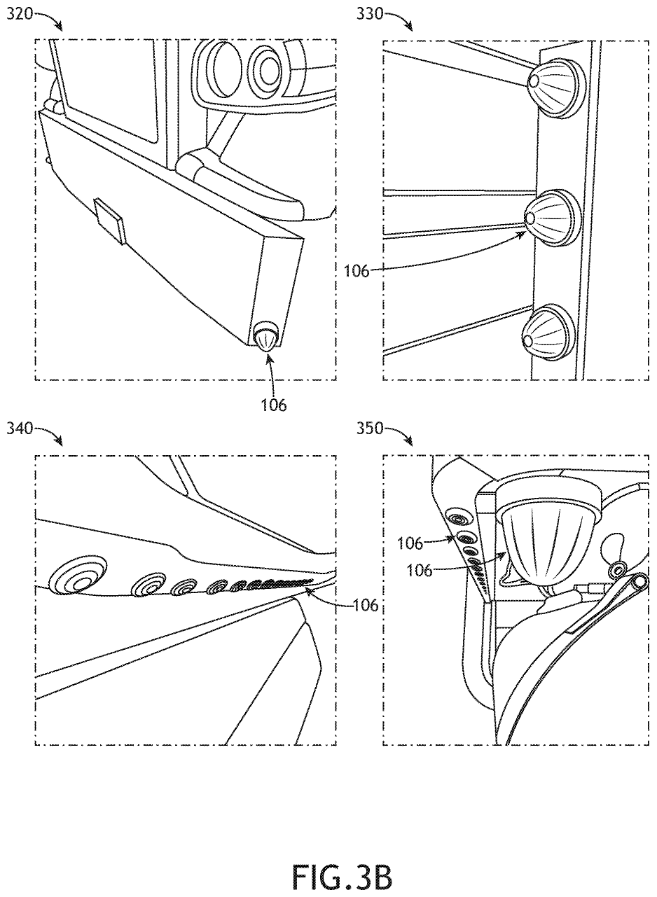

For example, the whip 102 may be configured to couple to at least one truck-side lighting output element 112 of a truck. See FIG. 3A for an example illustration of a rear bumper 304 of a truck 302 including a plurality of installed light assemblies 106, such as six installed light assemblies 106. The wire harness assembly 100 may be configured to be tucked into, under, or behind the rear bumper 304, side panel, front bumper, or the like.

Referring back to FIG. 1A, the truck-side lighting output elements 112 may be any element in the art or described herein that is suited to provide the signals. For example, the truck-side lighting output element 112 may include a bundle of wires terminating in wire ends, wires terminating in a single coupler (e.g., pinned or socketed electrical connector), two or more bundles of wires terminating in two or more respective couplers, and/or the like.

The truck-side lighting output elements 112 may transmit two or more distinct light signals (e.g., brake, turn, reverse, marker, and/or auxiliary) from a vehicle-side lighting output circuit 110.

In embodiments, the whip 102 includes two ends opposite each other. For example, a first end may include at least one couplable element 114. The at least one couplable element 114 may be configured to couple to the at least one truck-side lighting output element 112. The at least one truck-side lighting output element 112 and the at least one couplable element 114 may each include at least one of a connector or a plurality of wire leads. For example, if the truck-side lighting output element 112 includes a bundle of wires, the couplable element 114 may include a respective bundle of wires to be attached. By way of another example, if the truck-side lighting output element 112 includes one or more connectors, the couplable element 114 may include one or more respective connectors 114A. If a couplable element 114 is a connector 114A, that couplable element 114 of the whip 102 may be sized and keyed to mate directly with a respective connector of the truck-side lighting output elements 112.

The whip 102 may be interchangeable, modifiable (e.g., removable connector to expose wires), and/or the like to adapt to various truck light signal configurations of various original equipment manufacturers and/or aftermarket manufacturer configurations. For example, the whip 102 may be provided in multiple variants, each variant including a couplable element 114 configured to interface with a specific OEM or aftermarket connector format, such that a user may select and install the whip 102 variant corresponding to their specific truck model. For instance, a first whip 102 variant may include a couplable element 114 configured to interface with a seven-pin round trailer connector, while a second whip 102 variant may include a couplable element 114 in the form of bare wire leads configured for splicing to the truck-side lighting output elements 112.

A second end of the whip 102 may include a connector 116 opposite relative to the (first end) couplable element 114. The (second end) connector 116 may be electrically wired to and thereby coupled to the at least one couplable element 114. For example, conductors (e.g., wires, pins) from the couplable elements 114 may internally merge into a common jacket and terminate at a connector 116 at an opposite end of the whip 102. For instance, the connector 116 may include a sealed multi-pin connector.

In embodiments, the parallel-wired branch element 104 may include a first connector 118 of the parallel-wired branch element 104. The first connector 118 of the parallel-wired branch element 104 may be configured to be removably couplable to the connector 116 at the second end of the whip 102.

The parallel-wired branch element 104 may include a plurality of second connectors 120 branching out from the first connector 118. The plurality of second connectors 120 of the parallel-wired branch element 104 may be wired to and thereby coupled to the first connector 118. The plurality of second connectors 120 of the parallel-wired branch element 104 may be wired in parallel (e.g., spliced) such that each second connector receives identical power and signals from the first connector 118. This parallel wiring approach allows any light assembly 106 to be connected to any second connector 120, with the function of each light assembly 106 determined by how each light assembly is internally addressed or configured, rather than by which connector it is plugged into.

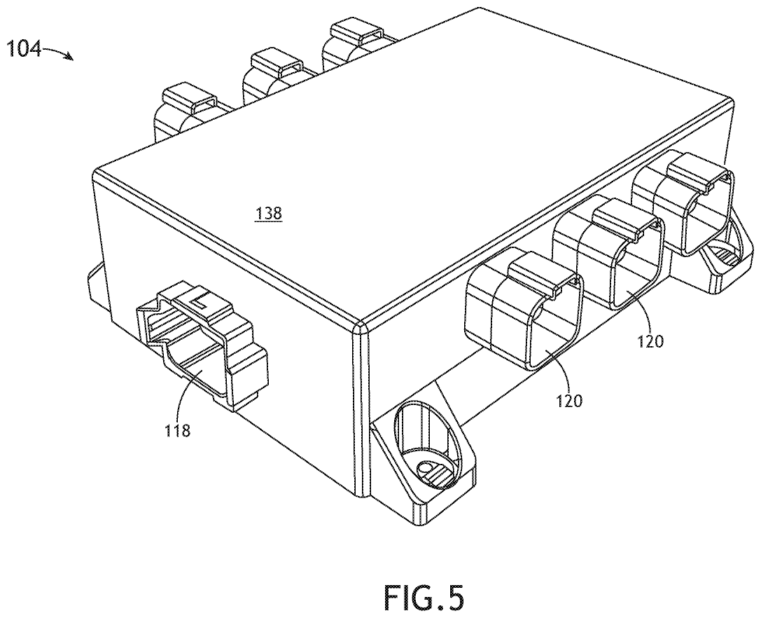

In embodiments, the parallel-wired branch element 104 may be configured as a flexible wire harness that branches out and/or may include a housing (e.g., rigid enclosure). For example, FIGS. 1A and 1B illustrate a flexible wire harness and FIGS. 1C and 5 illustrate a housing that encloses an internal parallel-wired branch based on an input connection (e.g., first connector 118). Any number of parallel-wired branch elements 104 in any suitable location may be used. For example, a parallel-wired branch element 104 may be located at a midway point of the vehicle and light assemblies 106 branched off the parallel-wired branch element 104 from there. This may reduce length of cable and labor needed compared to conventional solutions routing all cables an entire length back to the original vehicle circuitry.

The plurality of second connectors 120 of the parallel-wired branch element 104 may be all wired in parallel so that each includes and presents a same set of common power and signal lines. Each light assembly 106 may be addressable and configured internally to respond to a selected lighting function (e.g., brake, turn, reverse) when coupled to any of the second connectors 120.

The consistent parallel wiring of the parallel-wired branch element 104 may ensure that all connection points (e.g., pins, pairs of corresponding pins) of connector 116 are routed to identical positions in each second connector 120. For example, if the connector 116 includes a first pin carrying a brake signal, a second pin carrying a turn signal, a third pin carrying a reverse signal, a fourth pin carrying an auxiliary signal, and a fifth pin carrying a ground reference, each of the plurality of second connectors 120 of the parallel-wired branch element 104 may include a corresponding first pin carrying the brake signal, a corresponding second pin carrying the turn signal, a corresponding third pin carrying the reverse signal, a corresponding fourth pin carrying the auxiliary signal, and a corresponding fifth pin carrying the ground reference. Note that the specific number of pins and the specific signal types assigned to each pin position are nonlimiting examples, and the parallel-wired branch element 104 may include any suitable number of signal lines (e.g., two or more, four or more) and pin configurations. This ensures that power and all signal types (brake, turn, reverse, etc.) are available at every second connector 120, allowing flexibility in the placement and function of each light assembly 106. In some embodiments, the light assemblies 106 themselves are configured to respond only to their designated signal type, regardless of which second connector 120 they are plugged into. In some embodiments, the light assemblies 106 themselves are only configured to connect with certain connection elements (e.g., wires/pins/sockets), such as by having missing pins such that only desired pins are configured to make a connection.

Each light assembly 106 may include a light module 108 (e.g., LED light socket) and internal elements configured to determine which signal type the light assembly 106 responds to. Addressability may be provided in any suitable manner known in the art. For example, the internal elements may include a hard-wired pin-out, a dual in-line package (DIP) switch, a stored software identifier, a resistor-coding scheme, or the like. For instance, hard-wired pin-out may include that each connector cavity is dedicated to a particular function (e.g., cavity A=brake, B=tail, C=ground). Each light assembly 106 may include a light connector 122 (e.g., electrical plug connector) that may be configured to be removably coupled to any of the plurality of second connectors 120 of the parallel-wired branch element 104. For example, tabs, slots, recesses known in the art of electrical connectors or the like may be used to enable the connectors to connect and disconnect, non-destructively, by hand.

Note that the light assembly 106 does not necessarily include, in its manufactured state, a light/bulb. For example, the light assembly 106 may include a light module 108 configured to receive the signals and output light directly through a bulb and/or may include elements (e.g., sockets) configured to receive a bulb or the like for outputting the light. For example, the light module 108 may be a socket configured to receive a light/bulb. In this way, lights may be replaceable. However, in some embodiments, the light assembly 106 includes a light (e.g., LED light, light bulb, and/or the like).

In some embodiments, the light assembly 106 is configured to receive an auxiliary signal. For example, the light assembly 106 may include dual lights and/or sockets configured to output two or more light colors, a primary color and an auxiliary color.

The plurality of light assemblies 106 may include various types of addressable light functions. For example, a light assembly may be internally configured as a taillight that responds to taillight turn signals. Another light assembly may be internally configured as a reverse light that responds to reverse signals. Yet another light assembly may be internally configured as a brake light that responds to brake signals. The internal addressing of each may determine its function, rather than which connector it is plugged into.

FIG. 1B illustrates a schematic block diagram further illustrating an expandable parallel-wired branch element 130 coupled to a second connector 136 of the parallel-wired branch element 104 to increase the number of available connection points, in accordance with one or more embodiments of the present disclosure.

In embodiments, the expandable parallel-wired branch element 130 may be configured to couple to a single second connector 136 of the parallel-wired branch element 104. For example, the parallel-wired branch element 104 may include one or more connectors 136 configured for expansion. For instance, the one or more connectors 136 configured for expansion may be a same type of connector as connector 116 of the whip 102. Alternatively, the one or more connectors 136 configured for expansion may be a different type of connector than connector 116. In other words, the one or more connectors 136 configured for expansion may be dedicated for the purposes of expansion.

The expandable parallel-wired branch element 130 may include a first connector 132. The first connector 132 of the expandable parallel-wired branch element 130 may be configured to be removably couplable to connector 136 of the parallel-wired branch element 104. As noted earlier, connector 136 may be specifically configured for only connection with the first connector 132, or alternatively may be configured for connection with the same connector as connector 120 which may be dual-use for both expansion or connection to light assemblies 106.

A plurality of second connectors 134 of the expandable parallel-wired branch element 130 may be wired to and thereby coupled to the first connector 132 of the expandable parallel-wired branch element 130. The one or more second connectors 134 of the expandable parallel-wired branch element 130 may maintain the same parallel wiring as the parallel-wired branch element 104, carrying all signal types to each connector to accommodate any type of addressable light assembly.

FIG. 1C is a schematic block diagram of a wire harness assembly 100 including a parallel-wired branch element 104 that includes a housing 138, in accordance with one or more embodiments of the present disclosure.

For example, the housing 138 may be waterproof. The housing 138 may be a box, such as a plastic housing with the connections configured as ports on various sides of the housing 138. The housing 138 may be any shape and include any number of second connectors 120. For example, the housing 138 may include four or more second connectors 120, eight or more second connectors 120, or 14 or more second connectors 120. The internal wiring of the housing 138 may functionally be the same as a harness. For example, the internal wiring of the housing 138 may be a branched, pass-through, fully-wired, parallel wiring. For instance, parallel wiring may be spliced wires or the like.

Various wiring whip 102 and/or light assemblies may be used. As shown, the parallel-wired branch element 104 may be coupled to whips 102, which may be internally addressable, and/or the light assemblies 106 may be internally addressable. Although not shown, in some embodiments, the light assemblies 106 may be directly connected to the parallel-wired branch element 104, without a whip. As shown on the left, the light assembly 106 and/or whip 102 may be configured for multiple lights in a row with a jumper wire configuration, such as a whip 102 with a set of jumper wire connections as shown, or a single light assembly with a set of multiple lights along a length of cable. For example, this may be somewhat similar in wiring to traditional holiday lights on a home. In some embodiments, as shown in the middle, the whip 102 itself may be branched in a parallel wiring configuration to support multiple light assemblies 106. Alternatively, and/or in addition, although not shown, the light assemblies 106 themselves may be branched in a parallel wiring configuration to support multiple lights and/or sockets.

Various other configurations may be used in light assemblies 106 and/or whips 102. For example, a 6-pin connector on one end and three branched 3-prong connectors on the other end may be used. Alternatively, a 6-pin connector on one end and a 2 pin bullet connector on the other end may be used. These are nonlimiting and any suitable connectors and branch configurations may be used.

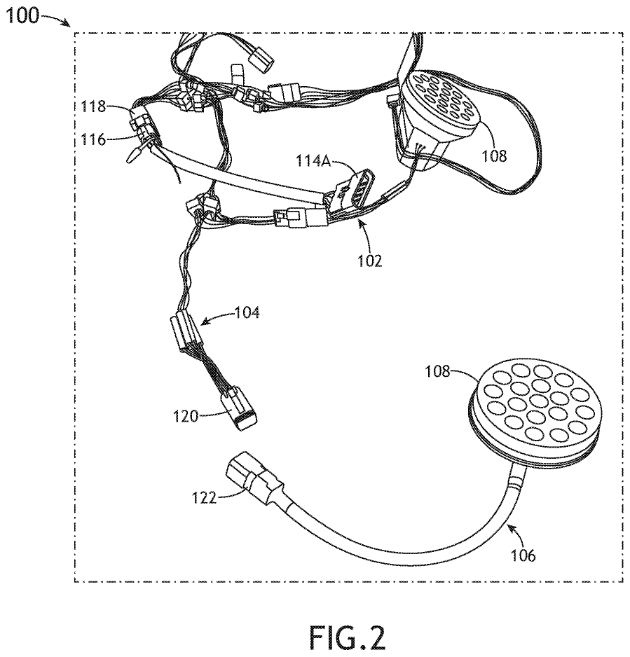

FIG. 2 illustrates a perspective view of the wire harness assembly 100 showing the whip 102 and the parallel-wired branch element 104, in accordance with one or more embodiments of the present disclosure.

In embodiments, any wiring configurations and connectors known in the art that are suitable for wiring harnesses may be used.

For example, each of the plurality of second connectors 120 of the parallel-wired branch element 104 may include a polarization-keyed, sealed multi-pin connector. In other words, each connector may be configured for a single orientation and type of plug so that pins, sockets, or the like are configured to only be plugged in one unique way. In embodiments, the connectors may provide sealed protection from the elements, such as water and dust. For instance, each of the plurality of second connectors 120 of the parallel-wired branch element 104 may include a Deutsch connector. In some embodiments, each of the plurality of second connectors 120 of the parallel-wired branch element 104 may include bullet connectors.

FIG. 3A is a perspective view of a rear bumper 304 of a truck 302 with installed light assemblies 106, in accordance with one or more embodiments of the present disclosure.

A system 306 may include both a truck outer surface panel (e.g., bumper 304, air cleaner panel, side panel, door panel, front bumper, rear bumper, or the like) and the wire harness assembly 100.

Although not shown in FIG. 3A, the wire harness assembly 100 may be configured to be tucked into, under, or behind the rear bumper 304.

The parallel-wired branch element 104 may include any number of second connectors 120. For example, the parallel-wired branch element 104 may include at least one second connector 120. For example, the parallel-wired branch element 104 may include at least five second connectors 120. For example, the parallel-wired branch element 104 may include at least eight second connectors 120.

As shown in FIG. 3A, the parallel-wired branch element 104 is configured for at least six second connectors 120 corresponding to six respective light assemblies 106.

FIG. 3B illustrates additional perspective views of light assemblies 106 of various panels 320, 330, 340, 350 of a truck, in accordance with one or more embodiments of the present disclosure.

For example, a front bumper 320, side panel 330, under-door panel 340, and additional panel 350 are shown, each with respective sets of light assemblies 106.

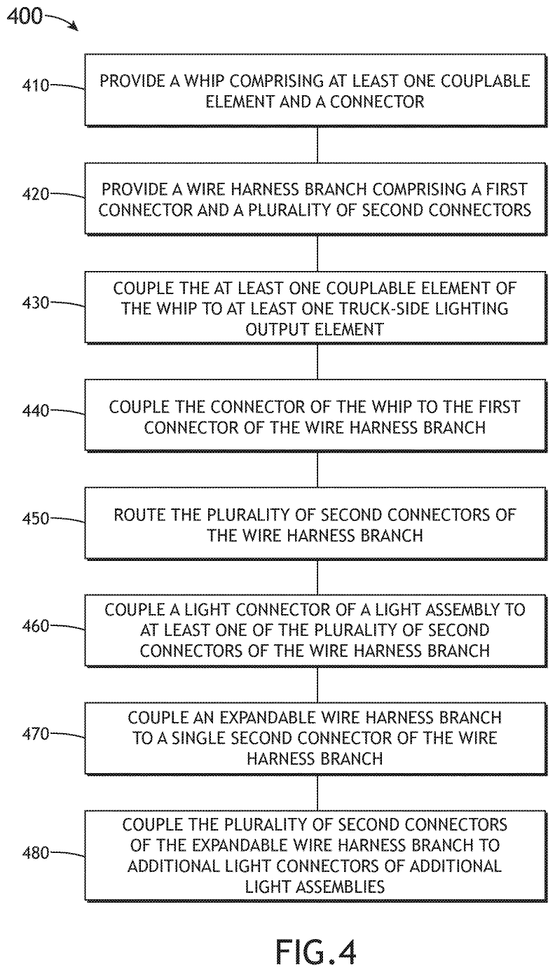

FIG. 4 illustrates a flow diagram depicting a method 400 for providing a wire harness assembly 100, in accordance with one or more embodiments of the present disclosure. It is noted that the embodiments and enabling technologies described previously herein in the context of the wire harness assembly 100 should be interpreted to extend to the method 400. It is further noted herein that the steps of method 400 may be implemented all or in part with wire harness assembly 100. It is further recognized, however, that the method 400 is not limited to the wire harness assembly 100 in that additional or alternative system-level embodiments may carry out all or part of the steps of method 400.

At step 410, a whip 102 may be provided (e.g., received from a manufacturer, and/or manufactured). The whip 102 may include at least one couplable or bare wire element 114 at a first end and a connector 116 at a second end.

At step 420, a parallel-wired branch element 104 may be provided. The parallel-wired branch element 104 may include a first connector 118 and a plurality of second connectors 120 electrically wired to and thereby coupled to the first connector 118.

At step 430, the at least one couplable or bare wire element 114 may be electrically coupled (e.g., plugged in, or twisted wires together) to at least one truck-side lighting output element 112 configured to supply a plurality of light signals.

At step 440, the connector 116 of the whip 102 may be removably coupled (e.g., plugged in) to the first connector 118 of the parallel-wired branch element 104.

At step 450, the plurality of second connectors 120 may be routed toward respective locations proximate a truck (e.g., panel of a truck 302).

At step 460, a light connector 122 of a light assembly 106 may be removably coupled to at least one of the plurality of second connectors to electrically couple the light assembly 106 to the common set of power and/or signal lines, such that the light assembly 106 responds to its designated signal type.

At step 470, an expandable parallel-wired branch element 130 may be coupled to a connector, which may be of the same type of connector as connector 120 of the parallel-wired branch element 104. In other words, connector 116, connector 120, and/or connector 136 may be the same type of connector. Such a connection may be performed via a first connector 132 of the expandable parallel-wired branch element 130. For example, parallel-wired branch element 104 may include one or more connectors 136 configured for expansion. For instance, the one or more connectors 136 configured for expansion may be a same type of connector as connector 116 of the whip 102 and/or a same type of connector as connector 120 of the parallel-wired branch element 104.

At step 480, a plurality of second connectors 134 of the expandable parallel-wired branch element 130 may be coupled to corresponding additional light connectors 122 of additional light assemblies 106 to provide the selected light signal to each additional light assembly 106. In this way, the common signal may be extended to any number of additional light assemblies 106 as desired using any number of expandable parallel-wired branch elementes 130.

FIG. 5 is a parallel-wired branch element 104 including a housing rather than a branched wire harness, in accordance with one or more embodiments of the present disclosure.

As noted earlier, the parallel-wired branch element 104 may include any number of second connectors 120 such as six or more, eight or more, 14 or more, or the like. The housing may define fastener holes configured to receive fasteners for mounting the housing anywhere in the vehicle.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A wire harness assembly configured for lighting of a truck, the wire harness assembly comprising:
a whip configured to couple to at least one truck-side lighting output element of the truck, the whip comprising:
at least one couplable element configured to couple to the at least one truck-side lighting output element, wherein the at least one truck-side lighting output element and the at least one couplable element each comprise at least one of a connector or a plurality of wire leads; and
a connector opposite relative to the at least one couplable element, wherein the connector is electrically wired to and thereby coupled to the at least one couplable element; and
a parallel-wired branch element configured to couple to the whip, the parallel-wired branch element comprising:
a first connector of the parallel-wired branch element configured to be removably couplable to the connector of the whip; and
a plurality of second connectors of the parallel-wired branch element wired to and thereby coupled to the first connector of the parallel-wired branch element,
wherein the plurality of second connectors of the parallel-wired branch element are wired in parallel such that each of the plurality of second connectors comprises one or more common signal lines, wherein the wire harness assembly is configured to couple to a plurality of light assemblies configured to be addressable.

2. The wire harness assembly of claim 1, further comprising an expandable parallel-wired branch element configured to couple to a single second connector of the parallel-wired branch element, wherein the expandable parallel-wired branch element comprises:
a first connector of the expandable parallel-wired branch element configured to be removably couplable to the single second connector of the parallel-wired branch element; and
a plurality of second connectors of the expandable parallel-wired branch element wired to and thereby coupled to the first connector of the expandable parallel-wired branch element,
wherein the plurality of second connectors of the expandable parallel-wired branch element are wired in parallel such that each of the plurality of second connectors of the expandable parallel-wired branch element comprises one or more common signal lines.

3. The wire harness assembly of claim 1, further comprising the plurality of light assemblies, each light assembly comprising:
a light; and
a light connector configured to be removably coupled to a second connector of the plurality of second connectors of the parallel-wired branch element.

4. The wire harness assembly of claim 3, wherein the plurality of light assemblies comprise:
a taillight light assembly configured to respond to at least one of: a taillight turn signal or an auxiliary signal;
a reverse light assembly configured to respond to at least one of: a reverse signal or an auxiliary signal;
a brake light assembly configured to respond to at least one of: a brake signal or an auxiliary signal; and
an auxiliary light assembly configured to respond to an auxiliary signal.

5. The wire harness assembly of claim 1, wherein the plurality of second connectors of the parallel-wired branch element comprise at least five second connectors.

6. The wire harness assembly of claim 1, wherein the plurality of second connectors of the parallel-wired branch element comprise at least eight second connectors.

7. The wire harness assembly of claim 1, wherein each of the plurality of second connectors of the parallel-wired branch element comprise a polarization-keyed, sealed multi-pin connector comprising a Deutsch connector.

8. A method of providing a wire harness assembly configured for lighting of a truck, the method comprising:
providing a whip comprising at least one couplable element and a connector electrically wired to and thereby coupled to the at least one couplable element;
providing a parallel-wired branch element comprising a first connector and a plurality of second connectors electrically wired to and thereby coupled to the first connector;
electrically coupling the at least one couplable element to at least one truck-side lighting output element of the truck; and
removably coupling the connector of the whip to the first connector of the parallel-wired branch element.

9. The method of claim 8, further comprising routing the plurality of second connectors of the parallel-wired branch element proximate the truck.

10. The method of claim 9, further comprising removably coupling a light connector of a light assembly to at least one of the plurality of second connectors of the parallel-wired branch element.

11. The method of claim 10, wherein the light assembly comprises a taillight light assembly configured to respond to a taillight turn signal.

12. The method of claim 10, further comprising coupling an expandable parallel-wired branch element to a single second connector of the parallel-wired branch element, the expandable parallel-wired branch element comprising a plurality of second connectors wired in parallel such that each second connector comprises one or more common signal lines available at the single second connector of the parallel-wired branch element.

13. The method of claim 12, further comprising removably coupling additional light connectors of additional light assemblies to the plurality of second connectors of the expandable parallel-wired branch element.

14. The method of claim 8, wherein the wire harness assembly comprises the plurality of second connectors of the parallel-wired branch element comprising at least eight second connectors.

15. A system comprising:
a panel of a truck; and
a wire harness assembly configured for the panel of the truck, the wire harness assembly comprising:
a whip configured to couple to at least one truck-side lighting output element of the truck, the whip comprising:
at least one couplable or bare wire element configured to couple to the at least one truck-side lighting output element, wherein the at least one truck-side lighting output element and the at least one couplable or bare wire element each comprise at least one of a connector or a plurality of wire leads; and
a connector opposite relative to the at least one couplable or bare wire element, wherein the connector is electrically wired to and thereby coupled to the at least one couplable or bare wire element; and
a parallel-wired branch element configured to couple to the whip, the parallel-wired branch element comprising:
a first connector of the parallel-wired branch element configured to be removably couplable to the connector of the whip; and
a plurality of second connectors of the parallel-wired branch element wired to and thereby coupled to the first connector of the parallel-wired branch element,
wherein the plurality of second connectors of the parallel-wired branch element are wired in parallel such that each of the plurality of second connectors comprises one or more common signal lines, wherein the wire harness assembly is configured to couple to a plurality of light assemblies configured to be addressable.

16. The system of claim 15, further comprising an expandable parallel-wired branch element configured to couple to a single second connector of the parallel-wired branch element, wherein the expandable parallel-wired branch element comprises:
a first connector of the expandable parallel-wired branch element configured to be removably couplable to the single second connector of the parallel-wired branch element; and
a plurality of second connectors of the expandable parallel-wired branch element wired to and thereby coupled to the first connector of the expandable parallel-wired branch element,
wherein the plurality of second connectors of the expandable parallel-wired branch element are wired in parallel such that each of the plurality of second connectors of the expandable parallel-wired branch element comprises the one or more common signal lines available at the single second connector of the parallel-wired branch element.

17. The system of claim 15, further comprising the plurality of light assemblies, each light assembly comprising: a light; and a light connector configured to be removably coupled to a second connector of the plurality of second connectors of the parallel-wired branch element.

18. The system of claim 17, wherein the plurality of light assemblies comprise: a taillight light assembly configured to respond to a taillight turn signal; a reverse light assembly configured to respond to a reverse signal; and a brake light assembly configured to respond to a brake signal.

19. The system of claim 15, wherein the plurality of second connectors of the parallel-wired branch element comprise at least five second connectors.

20. The system of claim 15, wherein the plurality of second connectors of the parallel-wired branch element comprise at least eight second connectors.
